(19) United States
(12) Patent Application Publication
(10) Pub. No.: US 2010/0287727 A1
(43) Pub. Date: Nov. 18, 2010

(54) Overhead Bi-Fold Door Assembly

(76) Inventor: Jim R. Suderman, Winkler (CA)

Correspondence Address: ADE & COMPANY INC., 2157 Henderson Highway, WINNIPEG, MB, R2G1P9, CA

(21) Appl. No.: 12/464,949

(22) Filed: May 13, 2009

(51) Int. Cl. E05D 15/38; E05D 11/00; E05D 5/02; E05D 5/10

(52) U.S. Cl. 16/2.1; 49/197; 16/387; 16/386

(57) ABSTRACT

An overhead bi-fold door assembly comprises an upper door frame and a lower door frame foldable relative to one another about a horizontal axis so as to be operable between a closed position and an open position in which the bottom end of the lower door frame is raised upwardly towards the top end of the upper frame member in relation to the closed position. Hinges which pivotally support the door each include a pair of leaves joining respective sets of knuckles in which the leaves span plural structural members of the respective door frames to provide added structural support to the door frames. Bushings are supported in the knuckles to receive the respective horizontal hinge pins of the hinges therein.

### FIELD OF THE INVENTION

The present invention relates to an overhead bi-fold door assembly comprising an upper section and a lower section foldable relative to one another between an open position and the a closed position spanning the opening of a building, and more particularly the present invention relates to a hinge construction in a bi-fold door assembly.

### BACKGROUND

Overhead bi-fold doors are commonly used for spanning large openings in buildings, for example buildings of the type for storing large equipment therein which require removal through the large opening in the building.

A typical bi-fold door comprises an upper section pivotal about a horizontal axis at a top end of the opening and a lower section pivotally coupled at a top end thereof to a bottom of the upper section about a horizontal axis such that the upper and lower sections are foldable relative to one another between a closed position lying substantially coplanar across the opening and an open position in which the sections are folded relative to one another such that the bottom of the lower section is raised upwardly adjacent the top of the upper section with the opening being substantially unobstructed by the door sections.

Because of the large size common with horizontal bi-fold doors, it is desirable wherever possible to reduce weight and reduce friction of the moving parts for ease of operation. A common hinge design between the upper and lower sections and between the upper section and the building comprises welding a plurality of hinge knuckles onto respective frame members of the door sections with the knuckles being aligned with one another to receive hinge pins commonly therethrough. The individual placement and anchoring of the knuckles makes it difficult to align the knuckles with a common hinge pin so that considerable wear and friction are commonly known due to the size and weight of the door. Also the construction of the frames require a considerable mass of material for strength in resist flexing of the frame relative to the hinge attachment locations which further increases the weight of the door.

### SUMMARY OF THE INVENTION

According to one aspect of the invention there is provided an overhead bi-fold door assembly arranged for being suspended from a top frame member spanning a top side of an opening of a building, the assembly comprising:

an upper door frame comprising an upper frame member spanning generally horizontally across a top end of the upper door frame, a lower frame member spanning across a bottom end of the upper door frame, and a plurality of intermediate frame members spanning between the upper frame member and the lower frame member;

a plurality of upper hinges comprising a plurality of first knuckles mounted on the top end of the upper door frame and a plurality of second knuckles arranged to be mounted on the top frame member of the building, the first and second knuckles receiving a common hinge pin horizontally therethrough such that the upper hinges are arranged to pivotally couple the top end of the upper door frame to the top frame member spanning the top side of the opening for pivotal movement of the upper door frame about a first horizontal pivot axis relative to the top frame member;

a lower door frame comprising a lower frame member spanning generally horizontally across a top end of the lower door frame, a lower frame member spanning across a bottom end of the lower door frame, and a plurality of intermediate frame members spanning between the upper frame member and the lower frame member;

a plurality of lower hinges comprising a plurality of first knuckles mounted on the top end of the lower door frame and a plurality of second knuckles arranged to be mounted on the bottom end of the upper door frame, the first and second knuckles receiving a common hinge pin horizontally therethrough such that the lower hinges are arranged to pivotally couple the top end of the lower door frame to the bottom end of the upper door frame for pivotal movement of the lower door frame about a second horizontal pivot axis relative to the upper door frame;

the upper door frame and the lower door frame being operable between a closed position spanning downwardly from the header across the opening and an open position in which the bottom end of the lower door frame is raised upwardly towards the top end of the upper frame member in relation to the closed position;

at least some of the hinges comprising bushings supported in the knuckles to receive the respective hinge pin therethrough.

Each of the knuckles of the upper hinges and the lower hinges preferably comprises a bushing supported therein and arranged to receive the respective hinge pin therethrough.

Each of the hinges may comprise an equal number of first and second knuckles, for example three first knuckles and three second knuckles, however the number of first or second knuckles may vary between the hinges depending upon different applications.

Preferably each knuckle receives a bushing section therein which spans in the direction of the pivot axis a length equal to the respective knuckle such that the bushing sections of each hinge are abutted directly against one another in an end to end configuration along the horizontal pivot axis.

The bushings preferably comprise a material that reduces wear and friction by being comprised so that the knuckles and the hinge pin are formed of a material which is harder than a material forming the bushings. For example, the bushings may comprise brass or other any suitable material, including various synthetic materials such as plastic and the like.

When the bushings are formed of brass or a like material, the material may be oil impregnated.

Each hinge pin may further comprise a readily releasable locking pin at one or both of the opposing ends thereof for selectively retaining the hinge pin within the respective knuckles.

According to a second aspect of the present invention there is provided an overhead bi-fold door assembly arranged for being suspended from a top frame member spanning a top side of an opening of a building, the assembly comprising:

an upper door frame comprising an upper frame member spanning generally horizontally across a top end of the upper door frame, a lower frame member spanning across a bottom end of the upper door frame, and a plurality of intermediate frame members spanning between the upper frame member and the lower frame member;

a plurality of upper hinges comprising a plurality of first knuckles joined integrally with a first leaf mounted flat against a surface of the upper frame member of the upper door frame and a plurality of second knuckles joined integrally with a second leaf arranged to be mounted on the top frame member of the building, the first and second knuckles receiving a common hinge pin horizontally therethrough such that the upper hinges are arranged to pivotally couple the top end of the upper door frame to the top frame member spanning the top side of the opening for pivotal movement of the upper door frame about a first horizontal pivot axis relative to the top frame member;

a lower door frame comprising a lower frame member spanning generally horizontally across a top end of the lower door frame, a lower frame member spanning across a bottom end of the lower door frame, and a plurality of intermediate frame members spanning between the upper frame member and the lower frame member;

a plurality of lower hinges comprising a plurality of first knuckles joined integrally with a first leaf mounted flat against a surface of the upper frame member of the lower door frame and a plurality of second knuckles joined integrally with a second leaf mounted flat against a surface of the lower frame member of the upper door frame, the first and second knuckles receiving a common hinge pin horizontally therethrough such that the lower hinges are arranged to pivotally couple the top end of the lower door frame to the bottom end of the upper door frame for pivotal movement of the lower door frame about a second horizontal pivot axis relative to the upper door frame;

the upper door frame and the lower door frame being operable between a closed position spanning downwardly from the header across the opening and an open position in which the bottom end of the lower door frame is raised upwardly towards the top end of the upper frame member in relation to the closed position.

Each leaf is preferably supported on the respective door frame at an intersection of the respective upper or lower frame member and one of the intermediate frame members of the door frame.

Each leaf may be arranged to overlap an inner side of both the respective upper or lower frame member and the intermediate frame member.

Each leaf may further comprise a plurality of apertures formed therein in alignment with one of the frame member in which the aperture are each filled with weld material joining the leaf to the respective frame member.

Each leaf preferably forms a gusset of material spanning laterally outward from opposing sides of the intermediate frame member towards the respective one of the upper or lower frame member.

Use of bushings in the upper and lower hinges provides for reduced friction at the hinges as well as assisting alignment between the knuckles to reduce wear of the hinge knuckles and the hinge pins. By providing bushings which are softer than the material of the hinge pins and knuckles, any wear occurs primarily on the bushings which can be readily replaced for continued ease of operation of the door movement between open and closed positions. By further arranging the knuckles to be integrally joined with a leaf anchored to the frame, the knuckles can be better aligned with one another and anchored to the frame in a more stable manner to strengthen the anchoring of the frame and reduce the strength and mass of the frame members required in the frame design. By further arranging the integral leaves of the hinges to span at least two frame members at an intersection thereof within each door frame, the leaves of the hinges each provide a gusset reinforcement at the frame member intersections for less flexing of the frame relative to the attachment points of the hinges. The leaves of the hinges in this instance provide a multiple purpose of better aligning the knuckles, anchoring the frame in a more stable manner relative to the hinges and increasing the strength of the frame member connections in the sections of the bi-fold door frame to increase strength of the frame member with less material usage and therefore less weight. The bi-fold door is thus handled more efficiently between open and closed positions thereof.

One embodiment of the invention will now be described in conjunction with the accompanying drawings in which:

### BRIEF DESCRIPTION OF THE DRAWINGS

FIG. 1 is a perspective view of a building supporting a bi-fold door in a closed position thereon.

FIG. 2 is a perceptive view of the building in which the door is shown in the open position.

FIG. 3 a schematic representation of the frame members of the assembled bi-fold door.

FIG. 4 is a perspective view of an inner side of the door frames of the door assembly illustrating some of the hinge locations in a partially open position.

FIG. 5 is a perspective view of an outer side of the door frames illustrating the hinge locations in a partially open position.

FIG. 6 is a perspective view of one of the hinges shown separated from the respective door frames of the door assembly.

FIG. 7 is an exploded perspective view of one of the hinges.

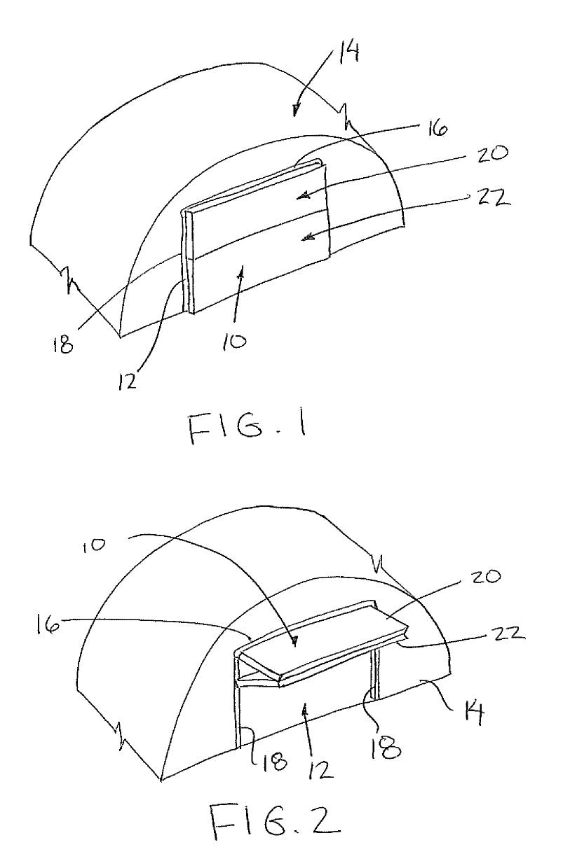

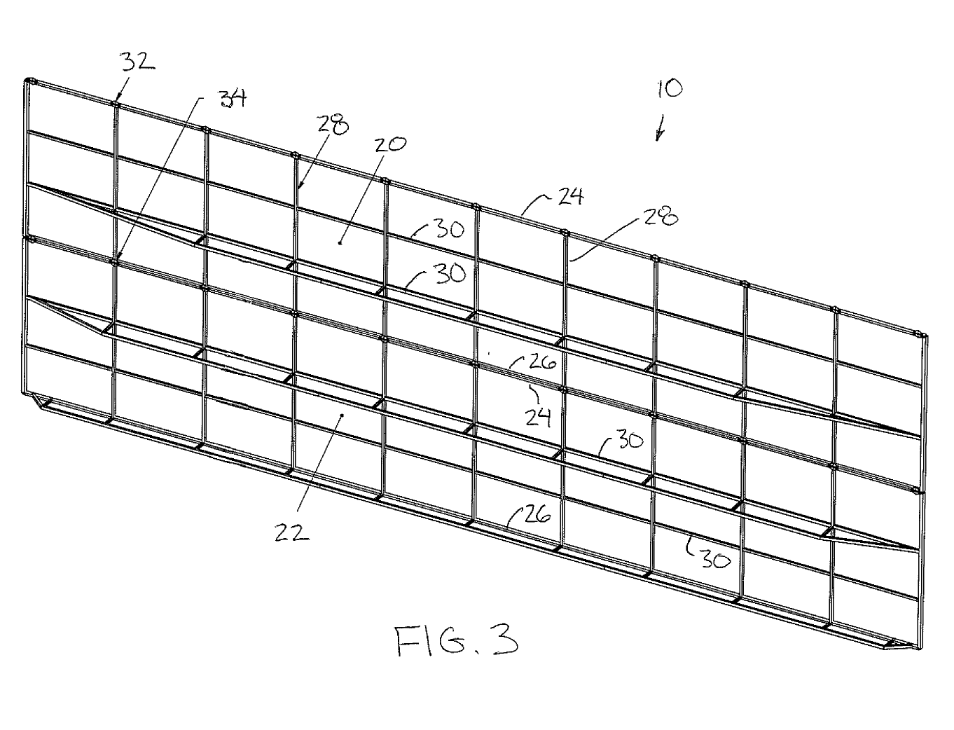

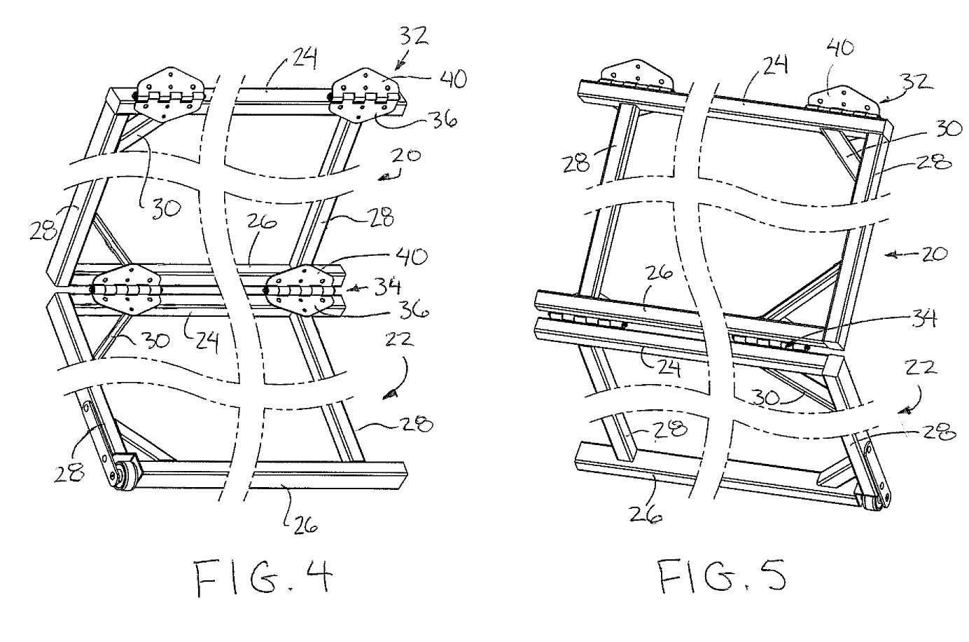

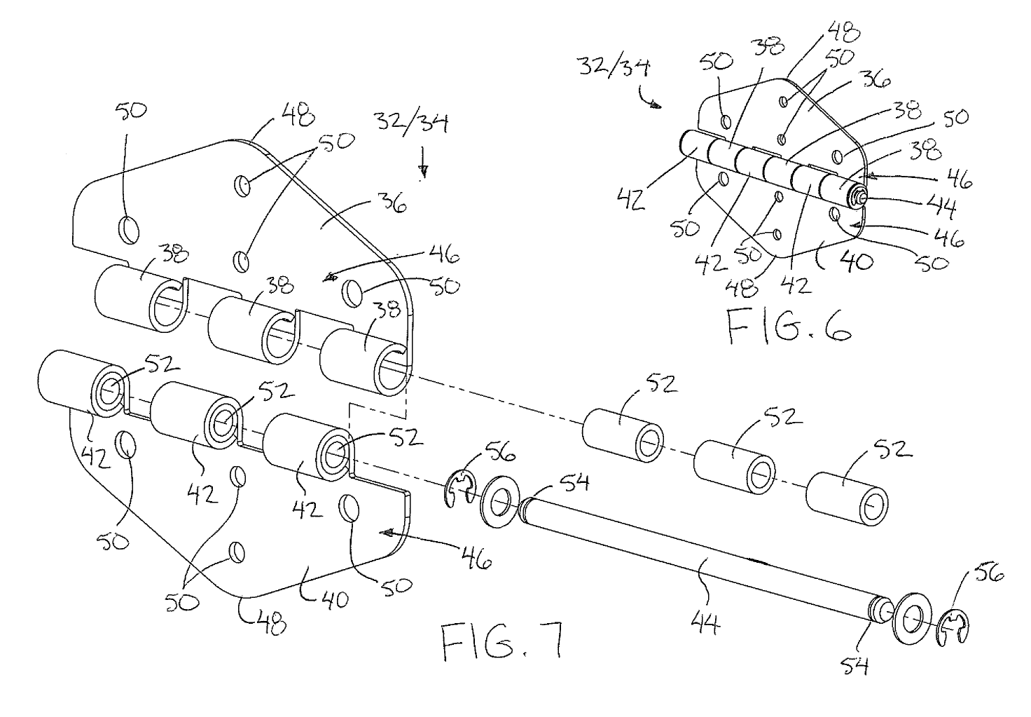

In the drawings like characters of reference indicate corresponding parts in the different figures.

### DETAILED DESCRIPTION

Referring to the accompanying figures there is illustrated an overhead bi-fold door assembly generally indicated by reference numeral 10. The door assembly 10 is particularly suited for operation between open and closed positions across an opening 12 in an upright side wall of a building 14, for example a large equipment storage building for providing access of the equipment in and out of the building through the opening 12. The building typically comprises a header in the form of a top frame member 16 spanning across the top end of the opening and a pair of side frame members 18 extending vertically along opposing sides of the opening between the top frame member 16 and the ground.

The door assembly generally comprises an upper door frame 20 and a lower door frame 22 which are pivotally coupled to one another and to the top frame member 16 of the building such that the door frames are operable between a closed position generally co-planar with one another in an upright orientation spanning downwardly from the top frame member 16 across the opening and an open position in which the door frames are folded relative to one another such that the bottom end of the lower door frame is raised upwardly towards the top end of the upper frame member in relation to the closed position such that the opening is substantially unobstructed by the door assembly.

Each of the upper and lower door frames comprises an upper frame member 24 comprising a horizontal beam spanning a full length of the door across the top end thereof. Each of the upper and lower door frames further comprises a lower frame member 26 which also comprises a horizontal beam spanning across a full length of the door frame across the bottom end thereof between opposing ends of the door assembly.

Each of the door frames further comprises a plurality of first auxiliary frame members 28 comprising intermediate frame members spanning generally vertically in orientation for connection between the upper frame member and the lower frame member of the respective door frame. In the illustrated embodiment, the intermediate frame members 28 are evenly spaced apart in the longitudinal direction of the upper and lower frame members at intermediate positions and at opposing ends of each of the door frames, however the spacing may vary depending upon the application.

A plurality of second auxiliary frame members 30 are connected horizontally between first auxiliary frame members at vertically spaced positions between the upper and lower frame members to be parallel thereto. Additional frame members 30 may be connected between the frame members noted above at various orientations such that some of the frame members form struts which span the corners of the door frames between the upper and lower frame members and the respective intermediate members at the ends of the door frames.

The door assembly further comprises a plurality of upper hinges 32 at longitudinally spaced positions along the upper frame member for pivotally coupling the upper frame member at the top end of the upper door frame to the top frame member 16 of the building at the top end of the opening. The upper hinges 32 commonly support the upper door frame for pivotal movement relative to the building about a common horizontal pivot axis of the upper hinges which is parallel to the longitudinal direction of the beams of the door frames.

A plurality of lower hinges 34 are also provided for pivotally coupling the upper frame member at the top end of the lower door frame to the lower frame member at the bottom end of the upper door frame for relative pivotal movement therebetween about a second horizontal axis lying parallel and spaced apart below the first horizontal axis.

Each upper hinge 32 comprises a first leaf 36 which is integrally joined with a plurality of first knuckles 38 of the hinge. The hinge further comprises a second leaf 40 which is integrally joined with a plurality of second knuckles 42. In the illustrated embodiment, each leaf supports three respective knuckles thereon at longitudinally spaced positions so that each adjacent pair of first knuckles is arranged to receive a respective one of the second knuckles in close tolerance therebetween. The number of first and second knuckles may vary depending upon the application.

Each of the knuckles is generally cylindrical in shape with an axial opening extending therethrough with the first and second knuckles mating together commonly about the first horizontal pivot axis so that each upper hinge receives a respective hinge pin 44 through the knuckles of the hinge. Each first leaf 36 is anchored to a flat inner side of the door frame at the top end thereof while each second leaf 40 is anchored to a corresponding flat surface of the top frame member of the opening in the building.

Each lower hinge 34 also comprises a first leaf 36 integrally joined with a plurality of first knuckles 38 and a second leaf 40 integrally joining a plurality of second knuckles 42 for mating engagement with one another commonly about the second horizontal pivot axis and for receiving a respective common hinge pin 44 through all of the knuckles of the hinge similarly to the upper hinges noted above.

Each of the leaves of the hinges comprises a wide base portion 46 arranged to span all of the knuckles integrally joined therewith. The base portion is tapered to be reduced in dimension between opposing edges thereof in the longitudinal direction as the leaf spans outwardly away from the knuckles. Accordingly the longitudinally opposed edges of each leaf taper inwardly towards one another with increasing distance from the knuckles to a central apex 48 at the outer edge of the leaf opposite the knuckles.

In the illustrated embodiment, a set of three apertures 50 extend through the flat plate forming each leaf at longitudinally spaced positions within the base portion 46 adjacent the knuckles for alignment with corresponding ones of the knuckles integrally joined with the leaf. An additional aperture 50 is also provided in the plate forming each leaf centered in the longitudinal direction adjacent the apex 48 so as to be spaced outwardly from the knuckles in relation to the three apertures along the base portion of the leaf. The apertures serve to mount the leaf to the corresponding frame member of the door assembly and may vary in number and placement according to the location and type of frame members to which the leaves are being coupled.

Each upper hinge 32 is mounted on the upper frame member 24 of the upper door frame 20 at an intersection between the upper frame member and a corresponding one of the intermediate frame members 28 such that one of the hinges is provided in association with each intermediate frame member of the door frame. The first leaf 36 of each upper hinge is fixed to the top end of the upper door frame so as to be parallel to and mounted flat against a flat inner surface of the upper frame member and a flat inner surface of the intermediate frame member by overlapping both frame members at the intersection thereof. The apertures provided in the base portion of the leaf are centered along the upper frame member between top and bottom edges thereof while the additional aperture 50 near the apex is centered on the intermediate frame member intersecting the upper frame member.

Each of the apertures is filed with weld material for connecting the leaf to the frame members. Outer edges of the leaf which overlap the frame members are also welded therebetween as well as welding the intersection of the side edges of the frame members with the inner surface of the leaf. In a mounted position each leaf spans from its apex centered on the respective intermediate frame member at a location spaced from the upper frame member so that the leaf spans laterally outward from opposing sides of the intermediate frame member towards the upper frame member for being joined with the upper frame member in a manner which forms a pair of gussets of material reinforcing the intersection between the frame members.

The second leaf of each upper hinge can be welded to the top frame member using weld material filling the apertures as noted above or the apertures can be used for receiving suitable fasteners to threadably fasten the second leaf of each upper hinge to the top frame member of the door opening as may be desired.

Each lower hinge 34 is also located at an intersection of a respective one of the intermediate frame members and the corresponding upper and lower frame members of the upper and lower door frames respectively. More particularly the first leaf 36 of each lower hinge is mounted at the top end of the lower door frame in a manner which is substantially identical to the mounting of the first leaf of the upper hinges to the top end of the upper door frame. More particularly the first leaf 36 of each lower hinge 34 is mounted parallel to and flat against the flat inner surface of the upper frame member of the lower door frame and the flat inner surface of the intersecting intermediate frame member for overlapping the inner side of both frame members at the intersection thereof. The apertures 50 adjacent the base portion are again aligned with the upper frame member while the other aperture 50 near the apex is aligned with the intermediate frame member for welding in the manner noted above.

Each second leaf 40 of the lower hinges 34 mounts against the lower frame member of the upper door frame so as to lie parallel to and flat against an inner flat surface of the lower frame member and a corresponding intersecting intermediate frame member. The apertures adjacent the base are again aligned with the horizontal beam of the lower frame member while the single aperture at the apex of the second leaf is aligned with the corresponding intermediate frame member for welding in the manner described above. The first and second leaves of the lower hinge are also positioned relative to the respective frame members to form a pair of gussets of material spanning outwardly from opposing sides of a respective one of the intermediate frame members to join the respective upper or lower frame member in a manner which reinforces the intersection of the frame members.

Each hinge further comprises bushings received within the knuckles of the hinges and which in turn receive the hinge pin 44 of the each upper and lower hinge therein. The bushings are formed in bushing sections 52 so that each knuckle of each hinge includes a respective one of the bushing sections 52 received therein. The bushing sections are generally cylindrical for being snugly received within the respective knuckles and include an axial opening therein through which the hinge pin is snugly received. Each bushing section 52 is mounted concentrically between the hinge pin and the respective knuckle about the respective horizontal pivot axis thereof.

The bushing sections 52 each have a length in the longitudinal direction of the respective pivot axis which corresponds to the full length of the respective knuckle within which it is mounted such that the bushings sections 52 of each hinge are abutted with one another in an end to end configuration along the axis. The bushing sections 52 are each formed of brass material which is oil impregnated. The hinge pins and the knuckles are formed of a harder cold worked steel so as to be harder than the bushings to concentrate the wear of the hinge to the readily replaceable bushings.

To ease in replacement of the bushings, the hinge pin of each hinge is arranged to be readily removable. The hinge pin of each upper and lower hinge is arranged to span all of the first and second knuckles of the respective hinge between opposing ends protruding from the opposing ends of the outermost first and second knuckles. At each of the opposing ends of the hinge pins 44 there is provided a suitable slot 54 which slidably receives a locking pin 56 therein. The locking pin is slidable in a radial direction and has a greater dimension in the radial direction than the hinge pin when in a mounted position to retain the hinge pin centered on the respective hinge. Slidably removing either one of the locking pins in the radial direction readily permits the hinge pin to be slidably removed in an axial direction for access the bushing sections 52 for removal and replacement as may be desired.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. The assembly according to claim 15 wherein at least some of the hinges comprise bushings supported in the knuckles to receive the respective hinge pin therethrough.

2. The assembly according to claim 1 wherein each of the knuckles of the upper hinges comprises a bushing supported therein and arranged to receive the respective hinge pin therethrough.

3. The assembly according to claim 1 where each of the knuckles of the lower hinges comprises a bushing supported therein arranged to receive the respective hinge pin therethrough.

4. The assembly according to claim 15 wherein each of the hinges comprises an equal number of first and second knuckles.

5. The assembly according to claim 1 wherein each knuckle receives a bushing section therein which spans in the direction of the pivot axis a length equal to the respective knuckle.

6. The assembly according to claim 5 wherein the bushing sections of each hinge are abutted directly against one another in an end to end configuration along the horizontal pivot axis.

7. The assembly according to claim 1 wherein the knuckles and the hinge pin are formed of a material which is harder than a material forming the bushings.

8. The assembly according to claim 1 wherein the bushings are formed of a material which is oil impregnated.

9. The assembly according to claim 1 wherein the bushings comprise brass.

10. The assembly according to claim 1 wherein each hinge pin comprise a readily releasable locking pin at each of the opposing ends thereof for selectively retaining the hinge pin within the respective knuckles.

11. (canceled)

12. (canceled)

13. (canceled)

14. (canceled)

15. An overhead bi-fold door assembly arranged for being suspended from a top frame member spanning a top side of an opening of a building, the assembly comprising:
an upper door frame comprising an upper frame member spanning generally horizontally across a top end of the upper door frame, a lower frame member spanning across a bottom end of the upper door frame, and a plurality of intermediate frame members spanning between the upper frame member and the lower frame member;
a plurality of upper hinges comprising a plurality of first knuckles joined integrally with a first leaf mounted flat against a surface of the upper frame member of the upper door frame and a plurality of second knuckles joined integrally with a second leaf arranged to be mounted on the top frame member of the building, the first and second knuckles receiving a common hinge pin horizontally therethrough such that the upper hinges are arranged to pivotally couple the top end of the upper door frame to the top frame member spanning the top side of the opening for pivotal movement of the upper door frame about a first horizontal pivot axis relative to the top frame member;
a lower door frame comprising an upper frame member spanning generally horizontally across a top end of the Lower door frame, a lower frame member spanning across a bottom end of the lower door frame, and a plurality of intermediate frame members spanning between the upper frame member and the lower frame member;
a plurality of lower hinges comprising a plurality of first knuckles joined integrally with a first leaf mounted flat against a surface of the upper frame member of the lower door frame and a plurality of second knuckles joined integrally with a second leaf mounted flat against a surface of the lower frame member of the upper door frame, the first and second knuckles receiving a common hinge pin horizontally therethrough such that the lower hinges are arranged to pivotally couple the top end of the lower door frame to the bottom end of the upper door frame for pivotal movement of the lower door frame about a second horizontal pivot axis relative to the upper door frame;
the upper door frame and the lower door frame being operable between a closed position spanning downwardly from the header across the opening and an open position in which the bottom end of the lower door frame is raised upwardly towards the top end of the upper frame member in relation to the closed position;
wherein each of the first leaf of the upper hinges and the first and second leaves of the lower hinges is arranged to be abutted flat against an inner side surface of the respective frame member at an intersection of a respective one of the upper or lower frame member and one of the intermediate frame members of the door frame such that the leaf is overlaps and is connected to both of the respective one of the upper or lower frame member and the intermediate frame member.

16. (canceled)

17. (canceled)

18. (canceled)

19. The assembly according to claim 15 wherein each of the first leaf of the upper hinges and the first and second leaves of the lower hinges forms a gusset of material spanning laterally outward from opposing sides of the intermediate frame member towards the respective one of the upper or lower frame member.

20. An overhead bi-fold door assembly arranged for being suspended from a top frame member spanning a top side of an opening of a building, the assembly comprising:
an upper door frame comprising an upper frame member spanning generally horizontally across a top end of the upper door frame, a lower frame member spanning across a bottom end of the upper door frame, and a plurality of intermediate frame members spanning between the upper frame member and the lower frame member;
a plurality of upper hinges comprising a plurality of first knuckles joined integrally with a first leaf mounted flat against a surface of the upper frame member of the upper door frame and a plurality of second knuckles joined integrally with a second leaf arranged to be mounted on the top frame member of the building, the first and second knuckles receiving a common hinge pin horizontally therethrough such that the upper hinges are arranged to pivotally couple the top end of the upper door frame to the top frame member spanning the top side of the opening for pivotal movement of the upper door frame about a first horizontal pivot axis relative to the top frame member;
a lower door frame comprising an upper frame member spanning generally horizontally across a top end of the lower door frame, a lower frame member spanning across a bottom end of the lower door frame, and a plurality of intermediate frame members spanning between the upper frame member and the lower frame member;
a plurality of lower hinges comprising a plurality of first knuckles joined integrally with a first leaf mounted flat against a surface of the upper frame member of the lower door frame and a plurality of second knuckles joined integrally with a second leaf mounted flat against a surface of the lower frame member of the upper door frame, the first and second knuckles receiving a common hinge pin horizontally therethrough such that the lower hinges are arranged to pivotally couple the top end of the lower door frame to the bottom end of the upper door frame for pivotal movement of the lower door frame about a second horizontal pivot axis relative to the upper door frame;
the upper door frame and the lower door frame being operable between a closed position spanning downwardly from the header across the opening and an open position in which the bottom end of the lower door frame is raised upwardly towards the top end of the upper frame member in relation to the closed position;
wherein each of the first leaf of the upper hinges and the first and second leaves of the lower hinges is arranged to be abutted flat against an inner side surface of the respective frame member at an intersection of a respective one of the upper or lower frame member and one of the intermediate frame members of the door frame such that the leaf is overlaps and is connected to both of the respective one of the upper or lower frame member and the intermediate frame member; and
wherein each of the first leaf of the upper hinges and the first and second leaves of the lower hinges includes a plurality of apertures formed therein in which the apertures of each leaf are in alignment with both the respective one of the upper or lower frame member and the intermediate frame member of the respective door frame and are filled with weld material connecting the leaf to both the respective one of the upper or lower frame member and the intermediate frame member of the respective door frame.

21. The assembly according to claim 15 wherein each leaf of the first leaf of the upper hinges and the first and second leaves of the lower hinges comprises a base portion spanning all of the knuckles of the leaf which reduces in dimension between opposing ends as the leaf spans outward from the knuckles to an apex opposite the knuckles which is arranged for alignment with the respective intermediate frame member to which the leaf is connected.

22. The assembly according to claim 20 wherein each of the first leaf of the upper hinges and the first and second leaves of the lower hinges forms a gusset of material spanning laterally outward from opposing sides of the intermediate frame member towards the respective one of the upper or lower frame member.

23. The assembly according to claim 20 wherein each leaf of the first leaf of the upper hinges and the first and second leaves of the lower hinges comprises a base portion spanning all of the knuckles of the leaf which reduces in dimension between opposing ends as the leaf spans outward from the knuckles to an apex opposite the knuckles which is arranged for alignment with the respective intermediate frame member to which the leaf is connected.
